(19) United States
(12) Patent Application Publication
(10) Pub. No.: US 2026/0074208 A1
(43) Pub. Date: Mar. 12, 2026

(54) NEGATIVE ELECTRODE MATERIAL AND BATTERY EMPLOYING SAME

(71) Applicant: Panasonic Intellectual Property Management Co., Ltd., Osaka (JP)

(72) Inventors: Kaori SHINODA, Osaka (JP); Yoshiaki TANAKA, Kyoto (JP); Akihiro SAKAI, Nara (JP)

(21) Appl. No.: 19/389,722

(22) Filed: Nov. 14, 2025

Related U.S. Application Data
(63) Continuation of application No. PCT/JP2024/011306, filed on Mar. 22, 2024.

(30) Foreign Application Priority Data
May 22, 2023 (JP) 2023-084074

(51) Int. Cl. H01M 4/485; H01M 4/02; H01M 4/62; H01M 6/18; H01M 10/0562

(52) U.S. Cl. CPC H01M 4/485; H01M 4/625; H01M 6/18; H01M 10/0562; H01M 2004/027; H01M 2300/0068

(57) ABSTRACT

A negative electrode material 1000 of the present disclosure includes a negative electrode active material 111, a sulfide solid electrolyte 100, and a conductive additive 110. The negative electrode active material 111 includes a lithium vanadium oxide, a proportion of a volume of the negative electrode active material 111 to a sum of the volume of the negative electrode active material 111 and a volume of the sulfide solid electrolyte 100 is 40% or more and 80% or less, and a proportion of a volume of the conductive additive 110 to a sum of the volume of the negative electrode active material 111, the volume of the sulfide solid electrolyte 100, and the volume of the conductive additive 110 is more than 4.4% and 15% or less.

This application is a continuation of PCT/JP2024/011306 filed on Mar. 22, 2024, which claims foreign priority of Japanese Patent Application No. 2023-084074 filed on May 22, 2023, the entire contents of both of which are incorporated herein by reference.

### BACKGROUND OF THE INVENTION

### 1. Field of the Invention

The present invention relates to a negative electrode material and a battery including the same.

### 2. Description of Related Art

Since having a low reaction potential and a high capacity, a lithium vanadium oxide (Li₃VO₄) has attracted attention as a next-generation negative electrode active material. JP 2008-077847 A discloses a non-aqueous secondary battery including the lithium vanadium oxide as a negative electrode active material.

### SUMMARY OF THE INVENTION

However, lithium vanadium oxides have poor electron conductivity. Therefore, it is difficult to obtain a battery having a sufficient capacity by using a lithium vanadium oxide as a negative electrode active material.

The electron conductivity of a negative electrode including a lithium vanadium oxide can be increased by increasing the amount of a conductive additive. However, increasing the amount of a conductive additive means decreasing the amount of an electrolyte and/or decreasing the amount of a lithium vanadium oxide as an active material. Decreasing the amount of an electrolyte results in decrease in the ion conductivity of a negative electrode. Decreasing the amount of a lithium vanadium oxide as an active material results in decrease in battery capacity.

The present disclosure aims to provide a technique for increasing the capacity of a battery including a lithium vanadium oxide.

The present disclosure provides a negative electrode material including:
a negative electrode active material;
a sulfide solid electrolyte; and
a conductive additive, wherein
the negative electrode active material includes a lithium vanadium oxide,
a proportion of a volume of the negative electrode active material to a sum of the volume of the negative electrode active material and a volume of the sulfide solid electrolyte is 40% or more and 80% or less, and
a proportion of a volume of the conductive additive to a sum of the volume of the negative electrode active material, the volume of the sulfide solid electrolyte, and the volume of the conductive additive is more than 4.4% and 15% or less.

According to the present disclosure, the capacity of a battery including a lithium vanadium oxide can be increased.

### BRIEF DESCRIPTION OF THE DRAWINGS

FIG. 1 is a cross-sectional view showing a negative electrode material 1000 according to a first embodiment.

FIG. 2 is a cross-sectional view showing a battery 2000 according to a second embodiment.

FIG. 3 is a cross-sectional view showing a battery 3000 of a modification.

### DETAILED DESCRIPTION

Embodiments of the present disclosure will be described hereinafter with reference to the drawings. The present disclosure is not limited to the embodiments below.

### First Embodiment

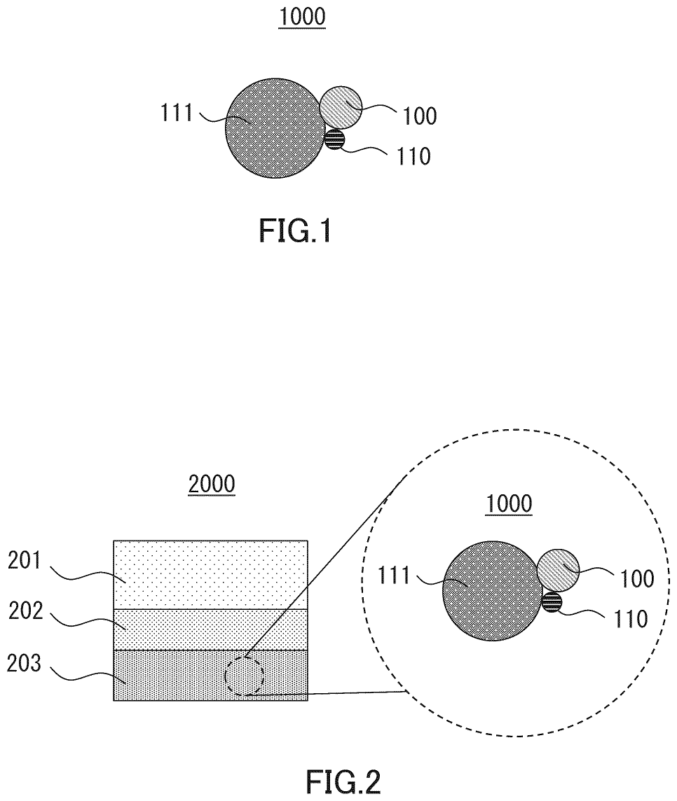

FIG. 1 is a cross-sectional view showing a negative electrode material 1000 according to a first embodiment. The negative electrode material 1000 includes a negative electrode active material 111, a sulfide solid electrolyte 100, and a conductive additive 110. The negative electrode active material 111, the sulfide solid electrolyte 100, and the conductive additive 110 each have the shape of a particle. The negative electrode active material 111 includes a lithium vanadium oxide. The lithium vanadium oxide is an oxide including lithium and vanadium. Herein, an oxide including lithium and vanadium is simply referred to as “vanadium oxide”.

In the negative electrode material 1000, a proportion of a volume of the negative electrode active material 111 to a sum of the volume of the negative electrode active material 111 and a volume of the sulfide solid electrolyte 100 is 40% or more and 80% or less. A proportion of a volume of the conductive additive 110 to a sum of the volume of the negative electrode active material 111, the volume of the sulfide solid electrolyte 100, and the volume of the conductive additive 110 is more than 4.4% and 15% or less. Thus, a good balance between the electron conductivity and the ion conductivity can be achieved in a negative electrode of a battery including the negative electrode material 1000. As a result, the battery including the negative electrode material 1000 has a high capacity.

The negative electrode material 1000 according to the first embodiment can be used, for example, to obtain a battery having excellent charge and discharge characteristics. The negative electrode material 1000 according to the first embodiment is suitable, for example, for increasing the battery capacity. The battery is, for example, a solid-state battery. The solid-state battery may be a primary battery or a secondary battery.

The vanadium oxide included in the negative electrode active material 111 can be a material represented by the following composition formula (1). In the composition formula (1), 0≤x<1.0 and 0≤α≤1.0 are satisfied. The symbol M is at least one element selected from the group consisting of a tetravalent metal element and a tetravalent metalloid element. Insertion of Li into and extraction of Li from the vanadium oxide represented by the composition formula (1) is enabled.

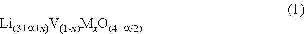

In the composition formula (1), 0<α<1.0 may be satisfied. That is, the vanadium oxide represented by the composition formula (1) may include Li and O in amounts exceeding those derived from stoichiometric composition. In this case, the negative electrode material 1000 of the first embodiment can increase the battery capacity. This is because the excess Li and O enhance the electron conductivity of the vanadium oxide, facilitating insertion of Li into and extraction of Li from the vanadium oxide. The stoichiometric composition means composition where a molar ratio between the elements forming the vanadium oxide is expressed by integral multiples. For example, Li₃VO₄ has stoichiometric composition.

Li and O in amounts expressed with a in the composition formula (1) may be inside a particle of the vanadium oxide, or may be present outside the particle as a second phase different from a first phase forming the particle.

In the composition formula (1), 0<α<0.85 may be satisfied, or 0.2≤α≤0.6 may be satisfied. In this case, the negative electrode material 1000 of the first embodiment can increase the battery capacity.

As described above, M is at least one element selected from the group consisting of the tetravalent metal element and the tetravalent metalloid element. Examples of the tetravalent metal element and the tetravalent metalloid element include Ti, Zr, Si, Ge, and Sn. When the pentavalent V element is substituted by the tetravalent metal element and/or the tetravalent metalloid element, a hole and/or a Li ion becomes a charge carrier. This further facilitates insertion of Li into and extraction of Li from the vanadium oxide.

In the composition formula (1), M may include Ti. In this case, the negative electrode material 1000 of the first embodiment can increase the battery capacity. The symbol M may be Ti.

In the composition formula (1), 0<x<1.0 may be satisfied. In this case, the negative electrode material 1000 of the first embodiment can increase the battery capacity. This is presumably because the electron conductivity of the vanadium oxide is enhanced by replacing one or some of vanadium ions with ion(s) of the metal M.

In the composition formula (1), 0<x≤0.1 may be satisfied. In this case, the negative electrode material 1000 of the first embodiment can increase the battery capacity. The symbol x may be 0.04 or more and 0.06 or less.

When x satisfies the above inequality in the composition formula (1), insertion of Li into and extraction of Li from the vanadium oxide is further facilitated. Therefore, as described above, the negative electrode material 1000 of the first embodiment can increase the battery capacity.

In terms of the energy density and the input-output characteristics of a battery, the proportion of the volume of the negative electrode active material 111 to the sum of the volume of the negative electrode active material 111 and the volume of the sulfide solid electrolyte 100 may be 50% or more. In this case, a further increase of the battery capacity can be expected.

In terms of the energy density and the input-output characteristics of a battery, the proportion of the volume of the negative electrode active material 111 to the sum of the volume of the negative electrode active material 111 and the volume of the sulfide solid electrolyte 100 may be 70% or less. In this case, a further increase of the battery capacity can be expected.

In terms of the energy density and the input-output characteristics of a battery, the proportion of the volume of the conductive additive 110 to the sum of the volume of the negative electrode active material 111, the volume of the sulfide solid electrolyte 100, and the volume of the conductive additive 110 may be 5.8% or more. In this case, a further increase of the battery capacity can be expected.

In terms of the energy density and the input-output characteristics of a battery, the proportion of the volume of the conductive additive 110 to the sum of the volume of the negative electrode active material 111, the volume of the sulfide solid electrolyte 100, and the volume of the conductive additive 110 may be 13.8% or less. In this case, a further increase of the battery capacity can be expected.

For a battery including the negative electrode material 1000, the volumes of the negative electrode active material 111, the sulfide solid electrolyte 100, and the conductive additive 110 each can be directly determined by obtaining a 3D SEM image of a negative electrode by 3D SEM observation of the negative electrode of the battery. 3D SEM observation is a method for obtaining a 3D image of an observation target by repeating focused ion beam processing and SEM observation.

A particle of the negative electrode active material 111 is a particle including the vanadium oxide. The particle of the negative electrode active material 111 may be a particle including the vanadium oxide represented by the composition formula (1). The particle including the vanadium oxide represented by the composition formula (1) as its principal component refers to a particle in which the component having the highest mass content is the vanadium oxide represented by the composition formula (1). The particle of the negative electrode active material 111 may be a particle consisting of the vanadium oxide represented by the composition formula (1).

The particles of the negative electrode active material 111 may have a median diameter of 0.1 μm or more and 100 μm or less. In the case where the particles of the negative electrode active material 111 have a median diameter of 0.1 μm or more, the particles of the negative electrode active material 111 and those of the sulfide solid electrolyte 100 can be favorably dispersed in a negative electrode of a battery. This improves the charge and discharge characteristics of the battery. In the case where the particles of the negative electrode active material 111 have a median diameter of 100 μm or less, the diffusion rate of lithium in the particles of the negative electrode active material 111 improves. This can allow the battery to operate at high power. The particles of the negative electrode active material 111 may have a median diameter of 0.5 μm or more and 10 μm or less.

The particles of the sulfide solid electrolyte 100 may have a median diameter of 1 nm or more and 10 μm or less, or may have a median diameter of 1 nm or more and 1 μm or less. This allows favorable dispersion of the negative electrode active material 111 and the sulfide solid electrolyte 100 in the negative electrode. The particles of the conductive additive 110 may have a median diameter of 1 nm or more and 100 μm or less.

The particles of the negative electrode active material 111 may have a median diameter larger than that of the particles of the sulfide solid electrolyte 100. This can allow favorable dispersion of the particles of the negative electrode active material 111 and the particles of the sulfide solid electrolyte 100.

The median diameter of particles means the particle size (d50) corresponding to 50% of a cumulative volume in a volumetric particle size distribution. The volumetric particle size distribution can be measured by a laser diffraction measurement device or an image analysis device.

The sulfide solid electrolyte 100 is a solid electrolyte including sulfur. Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

The conductive additive 110 enhances the electron conductivity of the negative electrode material 1000. Examples of the conductive additive 110 include: graphite, such as natural graphite or artificial graphite; carbon black, such as acetylene black or ketjen black; conductive fiber, such as carbon fiber or metal fiber; fluorinated carbon; metal powder, such as aluminum powder; conductive whiskers, such as a zinc oxide whisker or a potassium titanate whisker; conductive metal oxides, such as titanium oxide; and conductive polymer compounds, such as a polyaniline compound, a polypyrrole compound, and a polythiophene compound. The conductive additive may be a carbon material, such as carbon black or carbon fiber.

The shapes of the particle of the negative electrode active material 111, the particle of the sulfide solid electrolyte 100, and the conductive additive 110 are not limited. The shapes of these are, for example, an acicular, spherical, or ellipsoidal shape. The negative electrode active material 111 may be formed in the shape of a pellet or a plate.

### <Method for Manufacturing Vanadium Oxide>

The vanadium oxide as the negative electrode active material 111 can be manufactured by the following method.

Raw material powders are prepared so that target composition will be achieved. Examples of the raw material powders include an oxide, a hydroxide, a carbonate, a nitrate, and an organic salt.

As one example, it is assumed that, in the vanadium oxide represented by the composition formula (1) Li_{(3+α+x)}V₍₁₋ₓ₎MₓO_{(4+α/2)}, M is Ti and x and a are, respectively, 0.05 and 0 at mixing the raw materials. Then, Li₂CO₃, V₂O₅, and TiO₂ are mixed at a molar ratio of Li₂CO₃:V₂O₅:TiO₂=(3.05/2):(0.95/2):0.05.

In the case of α≠0, a substance serving as a Li source, such as Li₂CO₃, may be further added taking the value of a in target composition into account, followed by mixing the raw material powders. An excess of the Li source to be mixed in excess can be determined as appropriate according to, for example, the value of a in the target composition and the substance used as the Li source. In one example, to manufacture the vanadium oxide satisfying 0<x<1.0 and 0<α<1.0, the Li source may be used, for example, in a 0.5 mass % to 40 mass % excess or a 1 mass % to 30 mass % excess of a Li source amount determined in accordance with a molar ratio determined assuming that α is 0.

A lithium hydroxide or its hydrate may be used instead of Li₂CO₃.

The mixture of the raw material powders is fired to give a reaction product. An atmosphere in which the firing is performed may be atmospheric air or an inert gas atmosphere. The inert atmosphere is, for example, an argon atmosphere or a nitrogen atmosphere.

Alternatively, a reaction product may be obtained by causing a reaction of the mixture of the raw material powders in a mixer, such as a planetary ball mill, mechanochemically (by mechanochemical milling).

The vanadium oxide according to the first embodiment is obtained by these methods.

The molar ratio at the time of mixing the raw materials and the molar ratio in the reaction product are not necessarily equal to each other. This is because the raw materials may not be taken into the reaction product during the reaction because of evaporation.

The composition of the vanadium oxide is determined by quantitative analysis. Li is quantified by atomic absorption spectroscopy. V and M are quantified by high-frequency inductively-coupled plasma (ICP) emission spectrometry. The value of x in the composition formula (1) can be determined from an amount of the element M in the vanadium oxide.

The value of a in the composition formula (1) can be determined from the amount of Li and the amount of the element M in the vanadium oxide.

### Second Embodiment

A second embodiment will be described hereinafter. The features described in the first embodiment are omitted as appropriate.

A battery according to the second embodiment includes a positive electrode, an electrolyte layer, and a negative electrode. The electrolyte layer is disposed between the positive electrode and the negative electrode. The negative electrode includes the negative electrode material according to the first embodiment.

The battery according to the second embodiment has excellent charge and discharge characteristics.

FIG. 2 is a cross-sectional view showing a battery 2000 according to the second embodiment.

The battery 2000 includes a positive electrode 201, an electrolyte layer 202, and a negative electrode 203. The electrolyte layer 202 is disposed between the positive electrode 201 and the negative electrode 203.

The positive electrode 201 includes a positive electrode active material and a solid electrolyte.

The electrolyte layer 202 includes an electrolyte material. The electrolyte material is, for example, a solid electrolyte material.

The negative electrode 203 includes the negative electrode material 1000 of the first embodiment.

In order to increase the energy density and power output of the battery 2000, the negative electrode 203 may have a thickness of 10 μm or more and 500 μm or less.

The positive electrode 201 incudes a material capable of intercalating and deintercalating metal ions, such as lithium ions. The positive electrode 201 includes, for example, the positive electrode active material (for example, particles of the positive electrode active material).

Examples of the positive electrode active material include a lithium-containing transition metal oxide, a transition metal fluoride, a polyanion material, a fluorinated polyanion material, a transition metal sulfide, a transition metal oxysulfide, and a transition metal oxynitride. Examples of the lithium-containing transition metal oxide include Li(Ni, Co, Al)O₂, Li(Ni, Co, Mn)O₂, and LiCoO₂.

In the present disclosure, the expression “(A, B, C)” represents “at least one selected from the group consisting of A, B, and C”.

Lithium phosphate or a lithium-containing transition metal phosphate may be used as the positive electrode active material from the viewpoint of cost and safety of the battery 2000.

The particles of the positive electrode active material may have a median diameter of 0.1 μm or more and 100 μm or less. In the case where the particles of the positive electrode active material have a median diameter of 0.1 μm or more, the particles of the positive electrode active material and particles of the solid electrolyte can be favorably dispersed in the positive electrode 201. This improves the charge and discharge characteristics of the battery. In the case where the particles of the positive electrode active material have a median diameter of 100 μm or less, the diffusion rate of lithium in the particles of the positive electrode active material improves. This can allow the battery 2000 to operate at high power.

The particles of the positive electrode active material may have a median diameter larger than that of the particles of the solid electrolyte. This can allow favorable dispersion of the positive electrode active material particles and the solid electrolyte particles.

In order to increase the energy density and power output of the battery 2000, a ratio of the volume of the positive electrode active material to the sum of the volume of the positive electrode active material and the volume of the solid electrolyte may be 0.30 or more and 0.95 or less in the positive electrode 201.

To prevent the positive electrode active material from reacting with the solid electrolyte, a coating layer may be formed on a surface of the particle of the positive electrode active material. In this case, an increase of a reaction overvoltage of the battery can be suppressed. Examples of a coating material included in the coating layer include solid electrolytes, such as a sulfide solid electrolyte, an oxide solid electrolyte, a polymer solid electrolyte, and a halide solid electrolyte.

The coating material may be a halide solid electrolyte or an oxide solid electrolyte. The halide solid electrolyte may include F. This improves stability of the coating material at a high potential. Therefore, the battery 2000 has high charge and discharge efficiency. The oxide solid electrolyte may be lithium niobate or a polyanion material which has excellent stability even at a high potential. In this case, the battery 2000 has high charge and discharge efficiency.

In order to increase the energy density and power output of the battery 2000, the positive electrode 201 may have a thickness of 10 μm or more and 500 μm or less.

The solid electrolyte included in the positive electrode 201 may be a solid electrolyte, such as a sulfide solid electrolyte, a halide solid electrolyte, an oxide solid electrolyte, a polymer solid electrolyte, or an organic polymer solid electrolyte.

In the present disclosure, the term “sulfide solid electrolyte” means a solid electrolyte containing sulfur. The term “oxide solid electrolyte” means a solid electrolyte containing oxygen. The oxide solid electrolyte may contain an anion (excluding a sulfur anion and a halogen anion) other than oxygen. The term “halide solid electrolyte” means a solid electrolyte containing a halogen element and being free of sulfur. The halide solid electrolyte may contain not only the halogen element but also oxygen.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

Examples of the halide solid electrolyte include compounds represented by LiₐMe_{b}Y_{c}X₆. In the formula, the following equality and inequality are satisfied: a+mb+3c=6; and c>0. The symbol Me is at least one element selected from the group consisting of metal elements other than Li and Y and metalloid elements. The symbol X is at least one selected from the group consisting of F, Cl, Br, and I. The value of m represents the valence of Me.

The metalloid elements are B, Si, Ge, As, Sb, and Te. The metal elements are all the elements (except H) included in Groups 1 to 12 of the periodic table and all the elements (except B, Si, Ge, As, Sb, Te, C, N, P, O, S, and Se) included in Groups 13 to 16 of the periodic table.

In order to increase the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

Other examples of the halide solid electrolyte include compounds represented by Li_{α′}Me′_{β}O_{γ}X_{δ}. In the formula, α, β, γ, and δ are each greater than 0, Me′ is at least one element selected from the group consisting of metalloid elements and metal elements other than Li, X is at least one selected from the group consisting of Cl, Br, and I, and the following inequalities and equality are satisfied: 0.9≤α′≤1.2, β=1.0, 1.0≤γ≤1.3, and 3.6≤δ≤4.0.

Examples of the oxide solid electrolyte include:
(i) NASICON solid electrolytes, such as LiTi₂(PO₄)₃ and element-substituted substances thereof;
(ii) perovskite solid electrolytes, such as (LaLi)TiO₃;
(iii) LISICON solid electrolytes, such as Li₁₄ZnGe₄O₁₆, Li₄SiO₄, LiGeO₄, and element-substituted substances thereof;
(iv) garnet solid electrolytes, such as Li₇La₃Zr₂O₁₂ and element-substituted substances thereof; and
(v) Li₃PO₄ and N-substituted substances thereof.

Examples of the polymer solid electrolyte include a compound of a polymer compound and a lithium salt. The polymer compound may have an ethylene oxide structure. The polymer compound having an ethylene oxide structure can contain a large amount of lithium salt, and thus has higher ionic conductivity. The polymer solid electrolyte may be, for example, a composite compound of polyethylene oxide and a lithium salt. Such a polymer solid electrolyte is, for example, lithium bis(trifluoromethanesulfonyl)imide.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

The positive electrode 201 may include the above-described conductive additive in order to increase electronic conductivity.

The electrolyte layer 202 includes an electrolyte material. The electrolyte material is, for example, a solid electrolyte material. The electrolyte layer 202 may be a solid electrolyte layer. The solid electrolyte material included in the electrolyte layer 202 may be a sulfide solid electrolyte, a halide solid electrolyte, or a polymer solid electrolyte.

The electrolyte layer 202 may have a thickness of 1 μm or more and 100 μm or less. In the case where the electrolyte layer 202 has a thickness of 1 μm or more, short-circuiting between the positive electrode 201 and the negative electrode 203 is less likely to occur. In the case where the electrolyte layer 202 has a thickness of 100 μm or less, the battery 2000 can operate at high power.

In order to facilitate transfer of lithium ions and improve the output characteristics of the battery, at least one selected from the group consisting of the positive electrode 201, the electrolyte layer 202, and the negative electrode 203 may include a nonaqueous electrolyte solution, a gel electrolyte, or an ionic liquid.

The nonaqueous electrolyte solution contains a nonaqueous solvent and a lithium salt dissolved in the nonaqueous solvent. Examples of the nonaqueous solvent include a cyclic carbonate solvent, a linear carbonate solvent, a cyclic ether solvent, a linear ether solvent, a cyclic ester solvent, a linear ester solvent, and a fluorinated solvent. Examples of the cyclic carbonate solvent include ethylene carbonate, propylene carbonate, and butylene carbonate. Examples of the linear carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the linear ether solvent include 1,2-dimethoxyethane and 1,2-diethoxyethane. Examples of the cyclic ester solvent include γ-butyrolactone. Examples of the linear ester solvent include methyl acetate. Examples of the fluorinated solvent include fluoroethylene carbonate, methyl fluoropropionate, fluorobenzene, fluoroethyl methyl carbonate, and fluorodimethylene carbonate. One nonaqueous solvent selected from these may be used alone. Alternatively, a mixture of two or more nonaqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used. The concentration of the lithium salt is, for example, 0.5 mol/liter or more and 2 mol/liter or less.

As the gel electrolyte, a polymer material impregnated with a nonaqueous electrolyte solution can be used. Examples of the polymer material include polyethylene oxide, polyacrylonitrile, polyvinylidene fluoride, polymethyl methacrylate, and a polymer having an ethylene oxide bond.

Examples of cations contained in the ionic liquid include:
(i) aliphatic linear quaternary salts, such as tetraalkylammoniums and tetraalkylphosphoniums;
(ii) aliphatic cyclic ammoniums, such as pyrrolidiniums, morpholiniums, imidazoliniums, tetrahydropyrimidiniums, piperaziniums, and piperidiniums; and (iii) nitrogen-containing heterocyclic aromatic cations, such as pyridiniums and imidazoliums.

Examples of anions contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

In order to increase adhesion between the particles, at least one selected from the group consisting of the positive electrode 201, the electrolyte layer 202, and the negative electrode 203 may contain a binder.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. A copolymer may also be used as the binder. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from the above-described materials may be used as the binder.

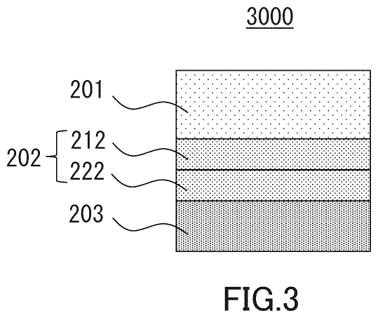

FIG. 3 is a cross-sectional view showing a battery 3000 of a modification. As shown in FIG. 3, another electrolyte layer (i.e., a second electrolyte layer) may be further provided between the electrolyte layer 202 and the negative electrode 203. When the electrolyte layer 202 is formed of a first electrolyte layer 212 and a second electrolyte layer 222, the second electrolyte layer 222 may be formed of another solid electrolyte material that is electrochemically more stable than the first electrolyte layer 212. Specifically, a reduction potential of the solid electrolyte material forming the second electrolyte layer 222 may be lower than a reduction potential of the solid electrolyte material forming the first electrolyte layer 212. In this case, the solid electrolyte material included in the first electrolyte layer 212 can be used without being reduced. Consequently, the charge and discharge efficiency of the battery 3000 can be enhanced.

Examples of the shape of the battery according to the second embodiment include coin type, cylindrical type, prismatic type, sheet type, button type, flat type, and stack type shapes.

The battery according to the second embodiment may be manufactured, for example, by preparing materials for forming a positive electrode, an electrolyte layer, and a negative electrode and then producing, by a known method, a stacked body in which the positive electrode, the electrolyte layer, and the negative electrode are disposed in this order.

### Other Embodiments

### (Supplement)

According to the description of the above embodiments, the following techniques are disclosed.

### (Technique 1)

A negative electrode material including:
a negative electrode active material;
a sulfide solid electrolyte; and
a conductive additive, wherein
the negative electrode active material includes a lithium vanadium oxide,
a proportion of a volume of the negative electrode active material to a sum of the volume of the negative electrode active material and a volume of the sulfide solid electrolyte is 40% or more and 80% or less, and
a proportion of a volume of the conductive additive to a sum of the volume of the negative electrode active material, the volume of the sulfide solid electrolyte, and the volume of the conductive additive is more than 4.4% and 15% or less.

According to Technique 1, a good balance between the electron conductivity and the ion conductivity can be achieved in a negative electrode of a battery including the negative electrode material. As a result, a battery including the negative electrode material has a high capacity.

### (Technique 2)

The negative electrode material according to Technique 1, wherein the lithium vanadium oxide is represented by a composition formula Li_{(3+α+x)}V₍₁₋ₓ₎MₓO_{(4+α/2)}, where 0≤x<1.0 and 0≤α≤1.0 are satisfied, and M is at least one element selected from the group consisting of a tetravalent metal element and a tetravalent metalloid element. Insertion of Li into and extraction of Li from the vanadium oxide represented by the composition formula (1) are enabled.

### (Technique 3)

The negative electrode material according to Technique 2, wherein the M includes Ti in the composition formula.

### (Technique 4)

The negative electrode material according to Technique 2 or 3, wherein 0<x<1.0 is satisfied in the composition formula.

### (Technique 5)

The negative electrode material according to Technique 2 or 3, wherein 0<x≤0.1 is satisfied in the composition formula.

### (Technique 6)

The negative electrode material according to any one of Techniques 2 to 5, wherein 0<α<1.0 is satisfied in the composition formula.

The negative electrode materials according to Techniques 3 to 6 are more suitable for increasing the battery capacity.

### (Technique 7)

The negative electrode material according to any one of Techniques 1 to 6, wherein the proportion of the volume of the negative electrode active material is 50% or more.

### (Technique 8)

The negative electrode material according to any one of Techniques 1 to 6, wherein the proportion of the volume of the negative electrode active material is 70% or less.

### (Technique 9)

The negative electrode material according to any one of Techniques 1 to 8, wherein the proportion of the volume of the conductive additive is 5.8% or more.

### (Technique 10)

The negative electrode material according to any one of Techniques 1 to 8, wherein the proportion of the volume of the conductive additive is 13.8% or less.

The negative electrode materials according to Techniques 7 to 10 can increase the energy density and enhance the input-output characteristics of a battery.

### (Technique 11)

A battery including:
a positive electrode;
a negative electrode including the negative electrode material according to any one of Techniques 1 to 10; and
an electrolyte layer disposed between the positive electrode and the negative electrode.

The battery according to Technique 11 has a high capacity.

### EXAMPLES

Hereinafter, details of the present disclosure will be described with reference to examples and comparative examples.

### Example 1

### [Production of Vanadium Oxide]

Li₂CO₃ (manufactured by Kojundo Chemical Laboratory Co., Ltd.; purity: 99.9%), V₂O₅ (manufactured by Kojundo Chemical Laboratory Co., Ltd.; purity: 99.9%), and TiO₂ (manufactured by Kojundo Chemical Laboratory Co., Ltd.; purity: 99.9%) were prepared as raw material powders at a molar ratio of Li₂CO₃:V₂O₅:TiO₂=1.525:0.475:0.05. The raw material powders were mixed in a mortar to give a powder mixture. The obtained powder mixture was provisionally fired in air at 600° C. for three hours. The provisionally fired powder was subjected to main firing in air at 920° C. for 15 hours. In both the provisional-firing and the main-firing, the temperature increase rate was 10° C. per minute, and the temperature decrease rate was 5° C. per minute. Thus, a vanadium oxide was obtained.

For the vanadium oxide, x and α in the composition formula (1) Li_{(3+α+x)}V₍₁₋ₓ₎MₓO_{(4+α/2)} were 0.05 and 0.06.

The value x was determined by analyzing an amount of Ti with an ICP emission spectrometer (PS3520VDDII manufactured by Hitachi High-Tech Science Corporation). The value α was determined by analyzing an amount of Li with an atomic absorption spectrophotometer (Z-2300 manufactured by Hitachi High-Technologies Corporation) and using the result of the analysis and that for the amount of Ti (that is, the value of x).

### [Production of Battery]

In an argon atmosphere with a dew point of −60° C. or lower, the vanadium oxide and Li₃PS₄ as a solid electrolyte were prepared such that the volume ratio between the vanadium oxide and the Li₃PS₄ was 60:40. These materials were mixed in an agate mortar. Next, acetylene black as a conductive additive was added in an amount of 8 mass % relative to the vanadium oxide, followed by mixing in an agate mortar. A negative electrode mixture (negative electrode material) was obtained in this manner. A proportion of a volume of the acetylene black to a total volume of the negative electrode mixture was 5.8%.

In an insulating cylinder having an inner diameter of 9.5 mm, Li₃PS₄ (80 mg) and the negative electrode mixture were stacked to give a stacked body. The negative electrode mixture was added such that the negative electrode active material weighed 3.78 mg. A pressure of 360 MPa was applied to the stacked body to form a solid electrolyte layer and a negative electrode. The solid electrolyte layer had a thickness of 500 μm.

Next, Li (thickness: 300 μm) was stacked on the solid electrolyte layer. A pressure of 80 MPa was applied to the resulting stacked body to form a positive electrode.

Next, current collectors formed of stainless steel were attached to the positive electrode and the negative electrode, and a current collector lead was attached to each of the current collectors.

Finally, an insulating ferrule was used to isolate the interior of the insulating cylinder from the outside air atmosphere, thereby sealing the interior of the cylinder.

A battery of Example 1 was obtained in the above manner. The battery of Example 1 is a monopolar test cell in which the negative electrode is used as a working electrode and the positive electrode is used as a counter electrode, and such a cell is used for testing the performance of the negative electrode. Specifically, the negative electrode to be tested is used as a working electrode, and an appropriate active material in an amount sufficient for a reaction of the working electrode is used for a counter electrode. In the case of this test cell, which was for testing the performance of the negative electrode, metal Li was used as the counter electrode. A negative electrode whose performance was tested by using such a test cell can be included in a secondary battery, for example, in combination with a positive electrode including a positive electrode active material, such as a Li-containing transition metal oxide, as described in the above embodiments.

### [Charge-Discharge Test]

The battery of Example 1 was disposed in a thermostatic chamber maintained at 25° C.

The battery of Example 1 was discharged at a current value corresponding to 0.1 C rate (10-hour rate) with respect to the theoretical capacity of the battery until the voltage reached 0.3 V. Next, the battery of Example 1 was charged at a current value corresponding to 0.05 C rate until the voltage reached 2.5 V. After two cycles of the charging and discharging at the above rates, discharging was performed at a current value corresponding to 0.5 C rate (2-hour rate) until the voltage reached 0.3 V. Moreover, charging was performed at a current value corresponding to 0.05 C rate until the voltage reached 2.5 V, and then discharging was performed at a current value corresponding to 1 C rate (1-hour rate) until the voltage reached 0.3 V.

According to the result of the charge-discharge test, the charge capacity of the battery of Example 1 at 0.5 C was 135.8 mAh/g. Since the batteries of Examples and Comparative Examples are each a half cell including a Li metal negative electrode, the charge capacities of the batteries of Examples and Comparative Examples correspond to the discharge capacity of a battery as described with reference to FIG. 2.

Examples 2 to 8 and Comparative Examples 1 to 4 below, the battery production method and the battery charge-discharge test method were the same as those in Example 1.

### Example 2

A battery of Example 2 was produced in the same manner as in Example 1, except that acetylene black as a conductive additive was added in an amount of 10 mass % relative to the vanadium oxide. In Example 2, the proportion of the volume of the acetylene black to the total volume of the negative electrode mixture was 7.1%.

According to the result of the charge-discharge test, the charge capacity of the battery of Example 2 at 0.5 C was 207.4 mAh/g.

### Example 3

A battery of Example 3 was produced in the same manner as in Example 1, except that acetylene black as a conductive additive was added in an amount of 12 mass % relative to the vanadium oxide. In Example 3, the proportion of the volume of the acetylene black to the total volume of the negative electrode mixture was 8.4%.

According to the result of the charge-discharge test, the charge capacity of the battery of Example 3 at 0.5 C was 230.6 mAh/g.

### Example 4

In an argon atmosphere with a dew point of −60° C. or lower, the vanadium oxide and Li₃PS₄ were prepared such that the volume ratio between the vanadium oxide and the Li₃PS₄ was 50:50. These materials were mixed in an agate mortar. Next, acetylene black as a conductive additive was added in an amount of 8 mass % relative to the vanadium oxide, followed by mixing in the agate mortar. A negative electrode mixture was obtained in this manner. The proportion of the volume of the acetylene black to the total volume of the negative electrode mixture was 7.1%.

A battery of Example 4 was produced in the same manner as in Example 1 using the negative electrode mixture. According to the result of the charge-discharge test, the charge capacity of the battery of Example 4 at 0.5 C was 190.7 mAh/g.

### Example 5

In an argon atmosphere with a dew point of −60° C. or lower, the vanadium oxide and Li₃PS₄ were prepared such that the volume ratio between the vanadium oxide and the Li₃PS₄ was 60:40. These materials were mixed in an agate mortar. Next, acetylene black as a conductive additive was added in an amount of 10 mass % relative to the vanadium oxide, followed by mixing in the agate mortar. A negative electrode mixture was obtained in this manner. The proportion of the volume of the acetylene black to the total volume of the negative electrode mixture was 10.0%.

A battery of Example 5 was produced in the same manner as in Example 1 using the negative electrode mixture. According to the result of the charge-discharge test, the charge capacity of the battery of Example 5 at 0.5 C was 261.5 mAh/g.

### Example 6

A battery of Example 6 was produced in the same manner as in Example 5, except that acetylene black as a conductive additive was added in an amount of 12 mass % relative to the vanadium oxide. In Example 6, the proportion of the volume of the acetylene black to the total volume of the negative electrode mixture was 12.1%.

According to the result of the charge-discharge test, the charge capacity of the battery of Example 6 at 0.5 C was 224.2 mAh/g.

### Example 7

A battery of Example 7 was produced in the same manner as in Example 5, except that acetylene black as a conductive additive was added in an amount of 14 mass % relative to the vanadium oxide. In Example 7, the proportion of the volume of the acetylene black to the total volume of the negative electrode mixture was 13.8%.

According to the result of the charge-discharge test, the charge capacity of the battery of Example 7 at 0.5 C was 223.4 mAh/g.

### Example 8

In an argon atmosphere with a dew point of −60° C. or lower, the vanadium oxide and Li₃PS₄ were prepared such that the volume ratio between the vanadium oxide and the Li₃PS₄ was 80:20. These materials were mixed in an agate mortar. Next, acetylene black as a conductive additive was added in an amount of 4 mass % relative to the vanadium oxide, followed by mixing in the agate mortar. A negative electrode mixture was obtained in this manner. The proportion of the volume of the acetylene black to the total volume of the negative electrode mixture was 5.8%.

A battery of Example 8 was produced in the same manner as in Example 1 using the negative electrode mixture. According to the result of the charge-discharge test, the charge capacity of the battery of Example 8 at 0.5 C was 146.0 mAh/g.

### Comparative Example 1

A battery of Comparative Example 1 was produced in the same manner as in Example 8, except that acetylene black as a conductive additive was added in an amount of 3 mass % relative to the vanadium oxide. In Comparative Example 1, the proportion of the volume of the acetylene black to the total volume of the negative electrode mixture was 4.4%.

According to the result of the charge-discharge test, the charge capacity of battery of Comparative Example 1 at 0.5 C was 0.01 mAh/g.

### Comparative Example 2

In an argon atmosphere with a dew point of −60° C. or lower, the vanadium oxide and Li₃PS₄ were prepared such that the volume ratio between the vanadium oxide and the Li₃PS₄ was 90:10. These materials were mixed in an agate mortar. Next, acetylene black as a conductive additive was added in an amount of 4 mass % relative to the vanadium oxide, followed by mixing in the agate mortar. A negative electrode mixture was obtained in this manner. The proportion of the volume of the acetylene black to the total volume of the negative electrode mixture was 6.4%.

A battery of Comparative Example 2 was produced in the same manner as in Example 1 using the negative electrode mixture. According to the result of the charge-discharge test, the charge capacity of the battery of Comparative Example 2 at 0.5 C was 0.1 mAh/g.

### Comparative Example 3

In an argon atmosphere with a dew point of −60° C. or lower, the vanadium oxide and Li₃PS₄ were prepared such that the volume ratio between the vanadium oxide and the Li₃PS₄ was 30:70. These materials were mixed in an agate mortar. Next, acetylene black as a conductive additive was added in an amount of 10 mass % relative to the vanadium oxide, followed by mixing in the agate mortar. A negative electrode mixture was obtained in this manner. The proportion of the volume of the acetylene black to the total volume of the negative electrode mixture was 5.4%.

A battery of Comparative Example 3 was produced in the same manner as in Example 1 using the negative electrode mixture. According to the result of the charge-discharge test, the charge capacity of the battery of Comparative Example 3 at 0.5 C was 0.08 mAh/g.

### Comparative Example 4

In an argon atmosphere with a dew point of −60° C. or lower, the vanadium oxide and Li₇La₃Zr₂O₁₂ as a solid electrolyte were prepared such that the volume ratio between the vanadium oxide and the Li₇La₃Zr₂O₁₂ was 60:40. These materials were mixed in an agate mortar. Next, acetylene black as a conductive additive was added in an amount of 10 mass % relative to the vanadium oxide, followed by mixing in the agate mortar. A negative electrode mixture was obtained in this manner. The proportion of the volume of the acetylene black to the total volume of the negative electrode mixture was 10.3%.

A battery of Comparative Example 4 was produced in the same manner as in Example 1 using the negative electrode mixture. According to the result of the charge-discharge test, the charge capacity of the battery of Comparative Example 4 at 0.5 C was 0.08 mAh/g.

TABLE 1

| | Proportion | Proportion of | 0.5 C | |
|---|---|---|---|---|
| | of volume | volume of | charge | 1 C |
| | of active | conductive | capacity | capacity |
| | material (%) | additive (%) | (mAh/g) | (mAh/g) |
| Example 1 | 40 | 5.8 | 135.8 | 101.0 |
| Example 2 | 40 | 7.1 | 207.4 | 177.9 |
| Example 3 | 40 | 8.4 | 230.6 | — |
| Example 4 | 50 | 7.1 | 190.7 | 161.8 |
| Example 5 | 60 | 10.0 | 261.5 | 221.8 |
| Example 6 | 60 | 12.1 | 224.2 | 200.4 |
| Example 7 | 60 | 13.8 | 223.4 | 179.2 |
| Example 8 | 80 | 5.8 | 146.0 | 68.0 |
| Comparative | 80 | 4.4 | 0.01 | — |
| Example 1 | | | | |
| Comparative | 90 | 6.4 | 0.1 | — |
| Example 2 | | | | |
| Comparative | 30 | 5.4 | 0.08 | — |
| Example 3 | | | | |
| Comparative | 60/40 LLZ | 10.3 | 0.08 | — |
| Example 4 | | | | |

### <<Discussion>>

As can be understood from Table 1, a high charge capacity was achieved by the batteries that include the vanadium oxide serving as a negative electrode active material and the sulfide solid electrolyte and where the proportion of the volume of the negative electrode active material to the sum of the volume of the negative electrode active material and the volume of the sulfide solid electrolyte is 40% or more and 80% or less and the proportion of the volume of the conductive additive to the total volume of the negative electrode mixture is more than 4.4% and 13.8% or less.

As can be understood by comparison between Comparative Example 1 and Example 8, when the volume proportion of the negative electrode active material was equal, the battery having a larger amount of conductive additive achieved a higher capacity.

As can be understood by comparison between Comparative Example 2 and Example 8, even when the proportion of the conductive additive was high, a low capacity was achieved in the case where the proportion of the sulfide solid electrolyte was low. It is thought that in Comparative Example 2, the amount of sulfide solid electrolyte was so low that the Li ion conductivity was insufficient.

For Examples 5 to 7, it has been confirmed that the 1C capacity decreased as the amount of conductive additive increased. This is attributable to inhibition of Li ion conduction by the conductive additive.

As can be understood by comparison between Comparative Example 4 and Example 5, a high charge capacity was achieved by including the sulfide solid electrolyte. Formation of an interface between the particles is thought to be insufficient in the hard oxide solid electrolyte because the materials were mixed in an agate mortar and the negative electrode mixture in a powder form was subjected to compression molding at room temperature.

### INDUSTRIAL APPLICABILITY

The negative electrode material of the present disclosure is used, for example, as a material of an all-solid-state lithium ion secondary battery.

What is claimed is:

1. A negative electrode material comprising:
a negative electrode active material;
a sulfide solid electrolyte; and
a conductive additive, wherein
the negative electrode active material comprises a lithium vanadium oxide,
a proportion of a volume of the negative electrode active material to a sum of the volume of the negative electrode active material and a volume of the sulfide solid electrolyte is 40% or more and 80% or less, and
a proportion of a volume of the conductive additive to a sum of the volume of the negative electrode active material, the volume of the sulfide solid electrolyte, and the volume of the conductive additive is more than 4.4% and 15% or less.

2. The negative electrode material according to claim 1, wherein
the lithium vanadium oxide is represented by a composition formula Li_{(3+α+x)}V₍₁₋ₓ₎MₓO_{(4+α/2)}, where 0≤x<1.0 and 0≤α≤1.0 are satisfied, and M is at least one element selected from the group consisting of a tetravalent metal element and a tetravalent metalloid element.

3. The negative electrode material according to claim 2, wherein the M comprises Ti in the composition formula.

4. The negative electrode material according to claim 2, wherein 0<x<1.0 is satisfied in the composition formula.

5. The negative electrode material according to claim 3, wherein 0<x≤0.1 is satisfied in the composition formula.

6. The negative electrode material according to claim 2, wherein 0<α<1.0 is satisfied in the composition formula.

7. The negative electrode material according to claim 1, wherein the proportion of the volume of the negative electrode active material is 50% or more.

8. The negative electrode material according to claim 1, wherein the proportion of the volume of the negative electrode active material is 70% or less.

9. The negative electrode material according to claim 1, wherein the proportion of the volume of the conductive additive is 5.8% or more.

10. The negative electrode material according to claim 1, wherein the proportion of the volume of the conductive additive is 13.8% or less.

11. A battery comprising:
a positive electrode;
a negative electrode comprising the negative electrode material according to claim 1; and
an electrolyte layer disposed between the positive electrode and the negative electrode.
